(19) United States
(12) Patent Application Publication
(10) Pub. No.: US 2002/0186934 A1
(43) Pub. Date: Dec. 12, 2002

(54) Optical termination

(76) Inventors: Norman L. Hug, Irvine, CA (US); George Schaeffer, Irvine, CA (US)

Correspondence Address: Curt Harrington, Suite 250, 6300 State University Drive, Long Beach, CA, 90815, US

(21) Appl. No.: 09/877,384

(22) Filed: Jun. 7, 2001

(51) Int. Cl. G02B 6/36

(52) U.S. Cl. 385/80; 385/78

(57) ABSTRACT

a complete termination system is disclosed which utilizes a connector body which is also utilizable for conductive contacts, since force is provided by a female force pin assembly acting within the connector body. The female force pin assembly, after being inserted first and locked into place, accepts force insertion of a male member and acts to back a specialized terminus body rearward out of a sleeve against the force of a spring and as the male terminus body moves to a locked position. The locked position maintains the female force pin assembly into continued guided alignment force contact with he tip of the male terminus body to insure that the interruption of the continuity of the fiber is (1) aligned, and (2) as close together as possible. As a multi point termination, a multi pin connector system is illustrated.

Further, a circuit board termination at the point of conversion from fiber optic signal to electrical signal is disclosed in embodiments for mounting on circuit boards and through walls, or both. Finally, a receptacle system is shown which utilizes the terminus body accepting structure of the connector body, with the electronic packaging accommodation space seen in the receptacle, to enable use with an electronics or optics generation structure having only a smooth aperture for insertion of the receptacle.

### FIELD OF THE INVENTION

This invention relates generally to the structures and methods for facilitating fiber optic connections, also known as terminations, to provide a more optimum and exacting connection.

### BACKGROUND OF THE INVENTION

As the technical utilizability of fiber optic information transmission has increased, the level of facility in providing the ability to make logical interconnects in the field has lagged. The main problems of non-alignment, spacing between opposing ends of the optic fibers, even more importantly a secure connection which affirmatively insures that a solid connection is made having uniform connection characteristics. Even more importantly, where a device has a multiple number of these connections, the providing of such multiple numbers of secure connections in a statistically highly reliable manner to insure that even the most complex assemblies are performed in at least an error-free manner as would be the case for making the same connections in a purely conductive electrical circuit.

One major goal of optical cable termination is to provide accurate alignment of the fiber within a terminus or fiber optic connector which enables connection and disconnection to be made by technicians. Where there is better alignment or concentricity of the fiber within the terminus structure, more light will be capable of being transmitted from the fiber to the opposing fiber of a mating terminus thus increasing optical power. The current state of the art for optical cable termination utilizes a separate component, referred to as an alignment ferrule composed of a hard ceramic or jewel material to align the fiber at the extreme forward of a terminus body. This alignment ferrule is typically press-fit or bonded to the inside of the terminus body. One drawback of the separate ferrule construction is that the additional manufacturing tolerances of the ferrule contribute to the difficulties in accurately aligning the fiber. The ceramic or jewel ferrule is also expensive to manufacture and adds assembly expense to the terminus.

A separate alignment ferrule of hard ceramic type material is currently provided to withstand the unpredictable abrasive forces exerted on the front of the terminus during the polishing of the fiber with hand held instruments or with automated equipment.

Further, the utility of the above limitations are also extremely affected by the precision, cost, and rejection rate for physically attaching the terminations to the end of the optic fibers. Methods which currently require large expensive machinery and a laboratory environment with high skill have an unduly negative impact upon the use of fiber optics in most applications. What is needed is good termination structures with fewer separate piece parts resulting in reducing the cumulative imprecision due to tolerance build-up and methods which are simple, require little skill of the user, and have a high probability of consistent accurate precision connection.

### SUMMARY OF THE INVENTION

A complete termination system is disclosed which utilizes a connector body which is also utilizable for conductive contacts, since force is provided by a female force pin assembly acting within the connector body. The female force pin assembly, which may, but does not have to be inserted first and locked into place, accepts force insertion of a male member and acts to back a specialized terminus body rearward out of a sleeve against the force of a spring and as the male terminus body moves to a locked position. The locked position maintains the female force pin assembly into continued guided alignment force contact with the tip of the male terminus body to insure that the interruption of the continuity of the fiber is (1) aligned, and (2) as close together as possible. This aligment can be referred to as “inherent” aligment, which indicates that upon connection, alignment will be achieved, and without further concern on behalf of an operator. As a multi point termination, a multi pin connector system is illustrated.

Further, a circuit board termination at the point of conversion from fiber optic signal, or vice versa (as in a transceiver) to electrical signal is disclosed in embodiments for mounting on circuit boards and through walls, or both. Finally, a receptacle system is shown which utilizes the terminus body accepting structure of the connector body, with the electronic packaging accommodation space seen in the receptacle, to enable use with an electronics or optics generation structure having only a smooth aperture for insertion of the receptacle.

### BRIEF DESCRIPTION OF THE DRAWINGS

The invention, its configuration, construction, and operation will be best further described in the following detailed description, taken in conjunction with the accompanying drawings in which:

FIG. 1 is a lateral outside view of a terminus body illustrating its external design simplicity;

FIG. 2 is an exploded view illustrating the mechanical components of the invention seen in a generalized relationship;

FIG. 3 is a view of the terminus body as seen in FIG. 2 but after expansion and curing of the epoxy from its preform state to its filled state;

FIG. 4 is an alternative embodiment of the terminus body similar to that seen in FIG. 1, but with different internal structures;

FIG. 5 is a further alternative embodiment of the terminus body similar to that seen in FIG. 1, but with an expanded volume chamber for supporting a larger volume and length of solid state epoxy preform;

FIG. 6 is a semi-sectional view of an optional insert which can be utilized for fiber centering and epoxy flow control;

FIG. 7 is an expanded sectional view of a length of solid state epoxy preform and keyed with dimensional reference indicators;

FIG. 8 is a cross sectional view of a sleeve and illustrating both internal and external structures;

FIG. 9 is a side and end view of a spring which fits within the sleeve shown in FIG. 8;

FIG. 10 is a side view of a collet;

FIG. 11 is a side sectional view of the collet of FIG. 10;

FIG. 12 is a front end view of the collet of FIG. 11;

FIG. 13 is a rear end view of the collet of FIG. 11;

FIG. 14 is a variation on the collet of FIGS. 10-13.

FIG. 15 is a side sectional view of a female force pin assembly with a collet attached to the end of a specialized terminus body fitted with a spring and a sleeve;

FIG. 16 is a sectional view similar to that seen in FIG. 15 but with different components forming its whole surface;

FIG. 17 is an exploded view of the embodiment seen in FIG. 16;

FIG. 18 is an exploded view of a connector body with moisture sealing grommets and locking rings and connectors oriented;

FIG. 19 is a view of the connector body of FIG. 16 seen in assembled condition;

FIG. 20 is a multiple view look at the locking ring seen in FIG. 19 and having three radially spaced apart inwardly bent locking fingers;

FIG. 21 is an end view of a locking ring having two inwardly bent locking fingers;

FIG. 22 is an end view of a locking ring having four inwardly bent locking fingers;

FIG. 23 is a side sectional and end view of a moisture seal grommet seen in FIG. 19;

FIG. 24 is a perspective view of a connector body in accord with the internals shown in FIG. 19;

FIG. 25 illustrates the connector body of FIG. 24 shown with a split plate support;

FIG. 26 illustrates the connector body of FIG. 24 shown with a split threaded half plate supports;

FIG. 27 illustrates a sectional view of two multi termination connectors illustrating the ability to mix electrical contact members and fiber optic members with the plug member and the receptacle members each having a fiber optic and a conducting termination;

FIG. 28 illustrates details of a terminus body utilized with the multi termination connectors of FIG. 27;

FIG. 29 illustrates details of an expanded view of the male terminus body area of the multi termination connectors of FIG. 27;

FIG. 30 illustrates details of a female force pin assembly utilized with the multi termination connectors of FIG. 24 and also seen in FIG. 27;

FIG. 31 illustrates details of an expanded view of the female force pin assembly area of the multi termination connectors of FIG. 27;

FIG. 32 illustrates a termination block looking into the circuit component accommodation space end of the block;

FIG. 33 illustrates a termination block view looking at the side of the block;

FIG. 34 illustrates a termination block looking into the terminus body entry end of the block;

FIG. 35 illustrates a side sectional view of the termination block and illustrating the internal spaces within the block;

FIG. 36 illustrates a variation of the view seen in FIG. 29 and having an additional tab groove;

FIG. 37 is an expanded view of the termination block as seen in FIGS. 32-35 in assembled condition;

FIG. 38 is a crushable ring having deformable ribs to align and fix an electronics package;

FIG. 39 is a variation upon the termination block seen in FIGS. 32-35 and having a threaded exterior for wall mounting;

FIG. 40 is a view of the termination block seen in FIG. 39 seen mounted on a circuit board and seen in exploded fashion with regard to through wall mounting hardware;

FIG. 41 is a perspective view of a hermetically sealed receptacle which is a hybrid between the connector body of FIG. 16 and the termination block of FIGS. 29-32 which can be used to insert into a structure containing a circuit component; and

FIG. 42 is a view of the receptacle of FIG. 37 inserted into a circuit component block, such as a detector that is a hermetically sealed component.

### DETAILED DESCRIPTION OF THE PREFERRED EMBODIMENT

Referring to FIG. 1, an external view of a terminus body 101 shown with an optical cable 103 extending from an opening in a second end 105 opposite a first end 107. The terminus body 101 is preferably cylindrical, and the dimensions given are simply one set of dimensions as shown on FIG. 1, but may change completely for another size of connector. A rear cylindrical section 111 has a diameter of 0.103 inches, and a length “A” of 0.252 inches. Rear cylindrical section 111 abuts a radially projecting land section 113 having a diameter of 0.132 inches and a length “B” of 0.046 inches. Adjacent the projecting land section 113 forward is a second, middle cylindrical section 115 having a diameter of 0.103 inches, and a length “C” of 0.122 inches. Forward of middle cylindrical section 115, a conic section 117 has an axial length “D” of 0.038 inches as it transitions from the diameter of 0.103 inches to 0.0625 inches. Forward cylindrical section 119 has an axial length “E” of 0.332 inches and a diameter of 0.0625 inches. Tolerances for the above dimensions preferably range from between 0.001 inches to 0.003 inches. The dimensions given, including 0.103, 0.046, 0.252, 0.122, 0.038, 0.0625, 0.332 and 0.132, for example, are only typical for this size termini & cable. Other dimensions will apply to other sizes of termini and cable.

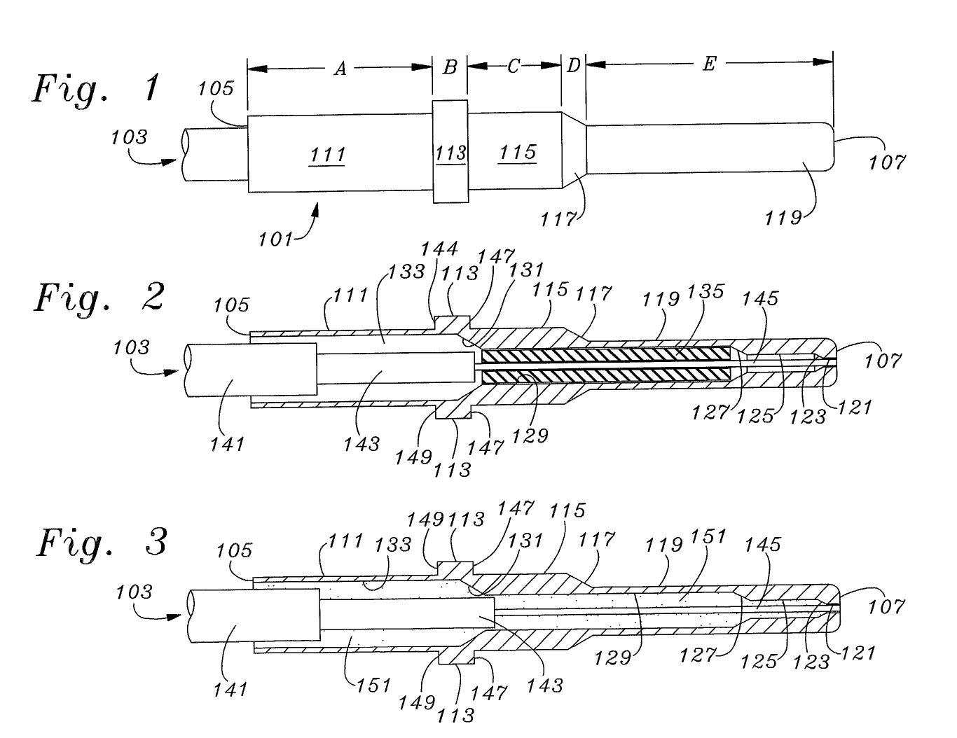

Referring to FIG. 2, the internals of the terminus body 101 are shown, especially in relation to the external features. Beginning at the first end 107, a first bore 121 is the smallest bore in the terminus body 101. First bore 121 leads to a first transitional conical section 123 and then to a larger second bore 125. Larger second bore 125 further leads to a second transitional conical section 127 and then to a larger third bore 129. Third bore 129 leads to a third transitional conical section 131 and then to a largest fourth bore 133. The terminus body 101, with its internal and external features, can be made from a single cutting tool.

Within the third bore 129 is a length of solid state epoxy preform 135. With regard to the entry of the length of solid state epoxy preform 135, the third conical section 131 helps to guide it in, while the second conical section 127 acts as a positive stop affirmatively limiting any further forward motion of the length of solid state epoxy preform 135. Epoxy preform 135 remains in the third bore 133 until the whole metal structure seen in FIG. 2 is heated (in the case of a thermally expanding substance, although other substances may be used) to an extent to cause the epoxy preform 135 to simultaneously melt and expand beyond the bore 133 in which it is contained, to fill all of the space inside the terminus body 101. In manufacturing, the epoxy preform may be machine inserted into the bore 133 to reduce the processing time. In the alternative, the preform 135 may be threaded onto any structure it is to support and center, regardless of any limitation on a terminus body 101. In practice, however, the preform 135 is very small and generally fragile. Any method which places it into its expansion starting point is permissible. Ideally, even flow is had into all the bores and conical transitions, including first bore 121, first transitional conical section 123, larger second bore 125, second transitional conical section 127, larger third bore 129, third transitional conical section 131, and largest fourth bore 133. Further details on the expansive flow will be explained. The cable jacket 141 utilizes the expanded epoxy to garner some stabilization within the terminus body 101 and for some distance away from terminus body 101. Again, triggering of the flow and expansion may be from any method, including and not limited to ultrasonics, heat, kinetic energy, or injection. Terminus body 101 may be fitted with ports to facilitate entry where a preform is not desired. Entry ports and the resulting processing may add unwanted steps to manufacture, but where insertion of the cable 103 and introduction of a fill material can be done in one step, it may become economically advantageous. The advantage of the preform 135 is that it is concentrically and radially evenly present at the start of its expansion, and is expected to and has shown to expand evenly in the interspace between the other structures present.

Further now distinguishable details of the optical cable are now seen. Optical cable 103 has a cable jacket 141 and a protective buffer 143, which may be made from polyimide. From within the protective buffer 143, an optic fiber 145 extends forward, through the length of solid state epoxy preform 135, and where desired, beyond the first end 107 of the terminus body 101. The protective buffer 143 is shown backed out partially away from the length of solid state epoxy preform 135 only in order to make it clear that these are separate structures.

The configuration shown in FIG. 2 may involve varying steps to yield a structure in which both protective buffer 143 and fiber 145 extend beyond the cable jacket 141 and further treatment or action for the fiber 145 to extend beyond the protective buffer 143. This may be done in automated fashion in an industrial surrounding, but the technique described produces good results even in the field and even for hand stripping. As usual, the stripping methods should leave the fiber 145 unscratched and in as good a condition as possible.

Once the components as shown in FIG. 2 are assembled in roughly the relationship seen in FIG. 2, the terminus body 101 may be heated sufficiently to cause the length of solid state epoxy preform 135 to expand significantly in volume while attaining a flowing liquid, albeit viscous, state. Keep in mind that before the beginning of the heating step that the optical cable is axially centered with respect to the terminus body 101. The length of solid state epoxy preform 135 lends significant support to the optical fiber 145. The only section over which the optical fiber is not supported is within the second bore 125, however it is precisely supported at the boundaries of this bore, by the length of solid state epoxy preform 135 at the conical section 127, and the first bore 121 at the conical section 123. Thus, before heating, the optical fiber 145 is already centered, and well held at the center of the terminus body 101.

Heating, especially where the terminus body 101 is made of a highly thermally conductive material will occur generally evenly at the situs of the solid state epoxy preform 135. Further, due to the already close quarters occupied by the solid state epoxy preform 135, expansion will occur most predominantly in the liquid state, i.e. the expansion will not cause half of the solid state epoxy preform 135 to “piston out” of its place. Heating can also be done radially inwardly as by inserting the terminus body in a heated block of metal, etc. Also seen more distinctly in FIG. 2 is a forward or first radial surface 147 of projecting land section 113 and an opposite rearward or second radial surface 149.

Referring to FIG. 3, a lateral semi-sectional view illustrates the assembly seen in FIG. 2 after heating and complete distribution of the solid state epoxy preform 135 which is shown as cured epoxy 151. The size and shape of the internals of the terminus body 101 is configured to enable complete forward and aft distribution of the cured epoxy 151. Cured epoxy 151 is seen to surround and stabilize the optic fiber 145, the protective buffer 143, and even the extent of cable jacket 141 within the second end 105 of the terminus body 101. The internal structure of the terminus body 101 is thus now fixed and extremely stable.

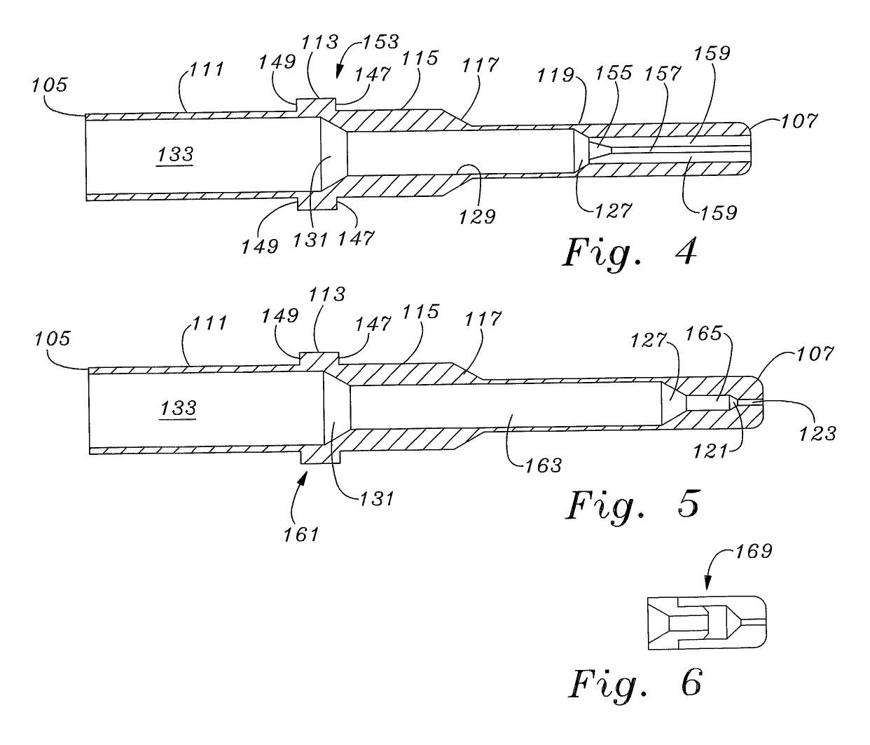

Referring to FIG. 4, an alternative embodiment is illustrated as a terminus body 153 and has the same external features seen for terminus body 101, but in a different proportion. Internally, the terminus body 153 differs from terminus body 101 forward of second transitional conical section 127. The second transitional conical section blends into a beveled section 155 of which only one angled surface is shown. The beveled section 155 leads to a reduced section 157. Rectangular section 157 may be surrounded by an adjacent guide section 159. Any guide structure which helps the fiber 145 remain centered may be used. The selection of the length of solid state epoxy preform 135, its melting temperature, its viscosity of flow characteristic and the clearance of the internals of any terminus body 101 or 153 will be selected with due consideration to the expansion of the length of solid state epoxy preform 135 in its liquid state, and the annular spaces around which it must flow, as well as the flow resistance. As an example, the rectangular section 157, if providing an exclusive channel for the flow of the epoxy will have its flow resistance balanced against the flow resistances at the rear of the terminus body 153. In this manner, there will be enough material flowing in both directions to insure full coverage and that the possibility of partial coverage in one direction will not occur.

Referring to FIG. 5, a further embodiment of a terminus body 161 is seen and having the same number and orientation of structures seen in FIG. 1, but having an enlarged third bore 163, and a reduced size second bore 165. This structure, for example, will enable the use of a much larger volume of length of solid state epoxy preform 135. The axial shorter length of second bore 165 will be advantageous in supporting a fiber 135 which is of lesser diameter. This overall design has the effect of flowing much more epoxy through much smaller areas.

Referring to FIG. 6, an insert and guide structure 169 is shown can be used as an insert within a terminus body, and especially with a smaller fiber 145. The insert and guide structure 169 can be inserted at the fore end of a terminus body 161, 153, or 101.

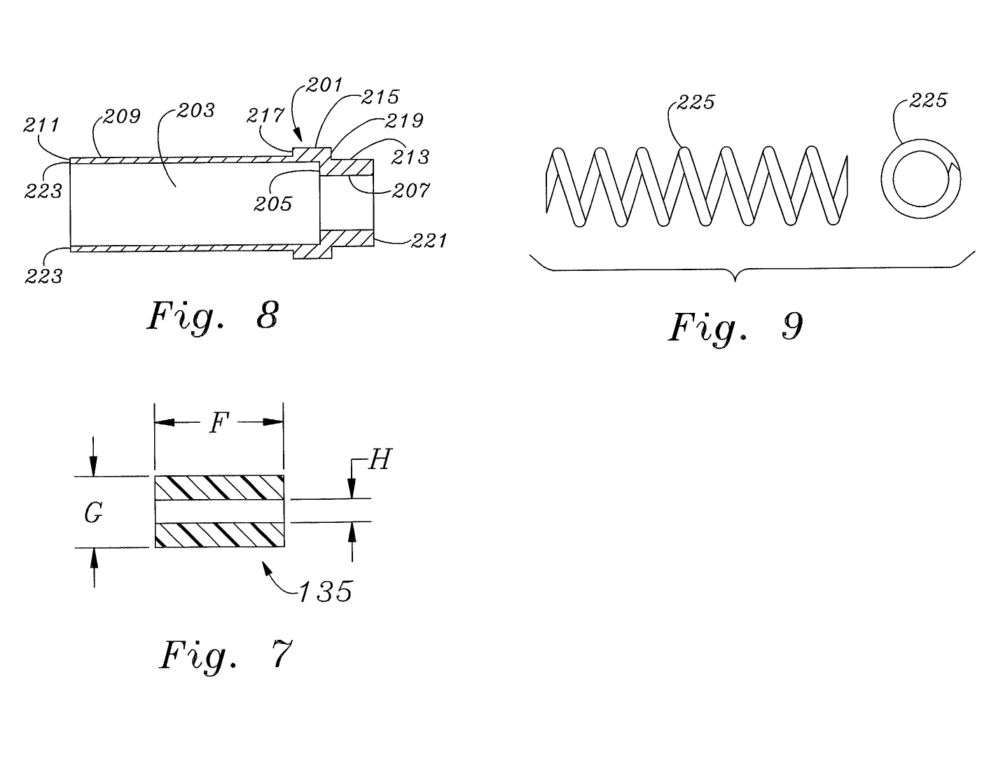

Referring to FIG. 7, an enlarged view of the length of solid state epoxy preform 135 is seen. The dimensions which have been found to work well with the terminus body 101 of FIG. 1 include an overall axial length “F” of about 0.50 inches, a diameter “G” of about 0.048 inches, and an internal bore diameter “H” of about 0.016 inches. Again, these dimensions may be typical, but other dimensions may be applicable depending upon the application. Variances are expected to vary depending upon the size and construction of fiber optic cable used.

In FIGS. 8-12, a series of components will be introduced and described which enable the construction of a highly reliable force loaded contact assembly in which the design eliminates error, provides concentricity with a terminus structure, and insures fiber optic transmission reliability.

Referring to FIG. 8 a sleeve 201 is shown. Sleeve 201 has a main internal cylindrical bore 203 separated by a stepped radial surface 205 from a smaller cylindrical chamber 207. Externally, the sleeve 201 has a first cylindrical surface 209 adjacent an end 211 and a second cylindrical surface 213, smaller than the first cylindrical surface 209. Between cylindrical surface 209 and cylindrical surface 213, a radially projecting land section 215 is seen. A pair of radial surfaces 217 and 219 flank either side of the radially projecting land section 215, and it will be seen to have the same function as radially projecting land section 113 previously seen in FIG. 1, the sleeve 201 for the purpose of a locking anchor to allow the achievement of force and motion within a fiber optic mating environment. A radial end surface 221 lies between cylindrical chamber 207 and second cylindrical surface 213. At end 211, a forward facing radial surface 223 is also seen.

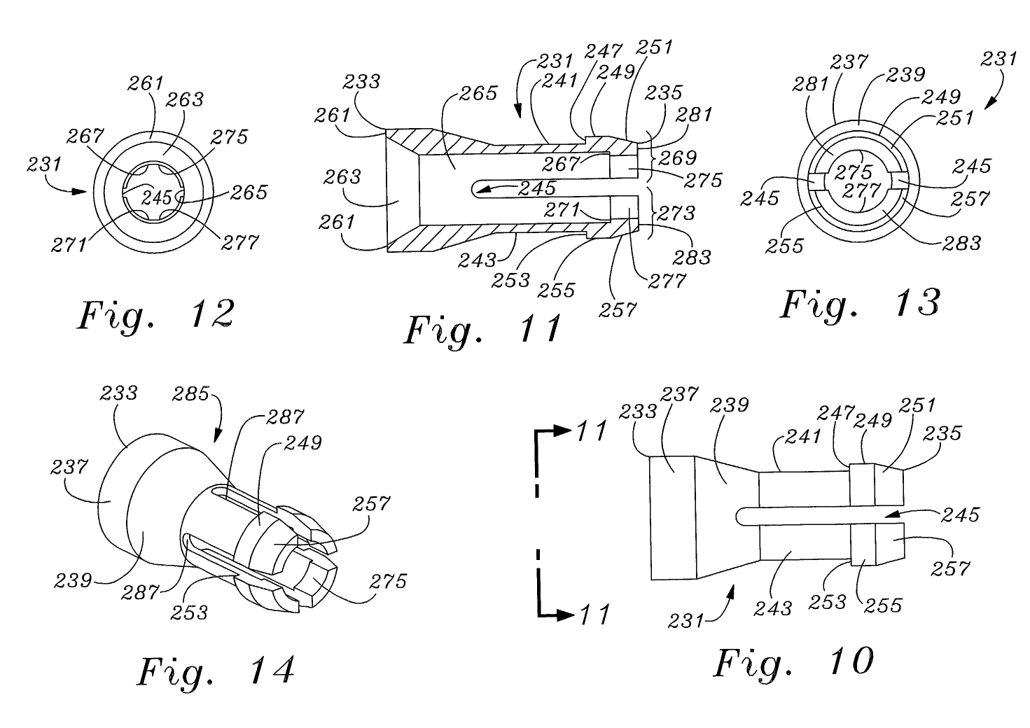

Referring to FIG. 9, a side and end view of a spring 225 is seen. This spring has an outer diameter to enable it to fit within the sleeve 201, but large enough to be effectively stopped by the stepped radial surface 205, and to use such surface to bear against within the main internal cylindrical bore 203.

Referring to FIG. 10, a collet 231 is shown as having a split body construction in order to enable flexing and locking onto a member to be shown subsequently. The external features are best initially seen in FIG. 10. Collet 231 has a first end 233 and a second end 235. From first end 233, a cylindrical surface portion 237 extends briefly and leads to an conical portion 239. Conical portion 239 leads to an upper hemi cylindrical portion 241 and a lower hemi cylindrical portion 243. The hemi cylindrical portions 241 and 243 occur due to the presence of a deep slot 245 which extends back a little more than one third into the conical portion 239. The deep slot 245 enables the hemi cylindrical portions 241 and 243 to flex toward and away from each other in a cantilevered manner.

From hemi cylindrical portion 241, a half circular radial surface 247 leads to a hemi cylindrical section 249, which leads to a hemi conical section 251 at second end 235. Similarly, from hemi cylindrical portion 243, a half circular radial surface 253 leads to a hemi cylindrical section 255, which leads to a hemi conical section 257 at second end 235.

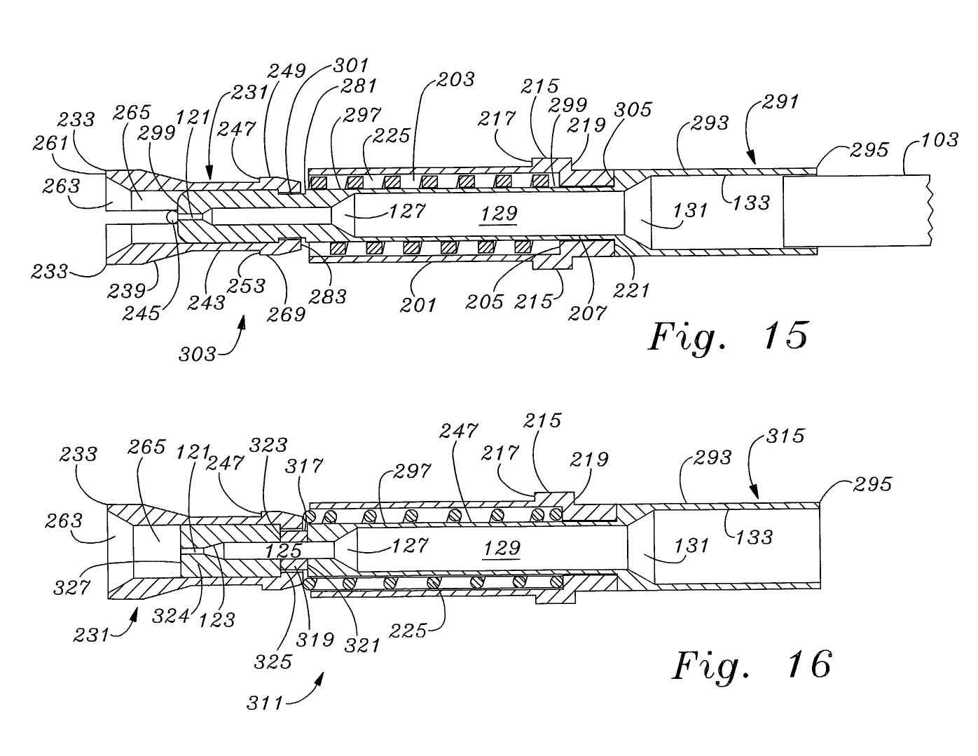

Referring to FIG. 11, a sectional view taken along line 11-11 of FIG. 10 is seen, and the internals of the collet 231 are illustrated. First end 233 is seen as having an abbreviated width radial surface 261 directed away from first end 233. The width of the surface 261 is selected to be thick enough to retain structural integrity, and thin enough to not interfere with the entry of a member pushed toward the collet 231. Inside collet adjacent radial surface 261 is an internal conical section 263 which is positioned to guide a member to an axial center of, but not necessarily into the end of an internal cylindrical portion 265. The internal cylindrical portion 265 ends at an abbreviated radial surface 267 at a first hemi cylindrical member 269 which includes cylindrical portion 241, a half circular radial surface 247, hemi cylindrical section 249, and hemi conical section 251, and internal cylindrical portion 265 ends at an abbreviated radial surface 271 at a second hemi cylindrical member 273 which includes hemi cylindrical portion 243, half circular radial surface 253 leads to a hemi cylindrical section 255, and hemi conical section 257.

The relatively stiff cantilever action from hemi cylindrical members 269 and 273 enable circular abbreviated radial surfaces 267, 271 to make a secure lock upon any structure surrounded. Adjacent the surfaces 267 and 271 are inwardly directed hemi-circular surfaces 275 and 277, respectively. At the front end of the collet 231, a radial surface 281 lies at the boundary between inwardly directed hemi-circular surfaces 275 and hemi conical section 251. Similarly, at the lower front end of the collet 231, a radial surface 283 lies at the boundary between inwardly directed hemi-circular surfaces 277 and hemi conical section 257.

Referring to FIG. 12, a view looking into the first end 233 of the collet 231 seen in FIG. 11 is illustrated. Structures and features seen in FIG. 12 are, from concentrically outward to inward include abbreviated width radial surface 261, internal conical section 263, internal cylindrical portion 265, abbreviated radial surface 267, abbreviated radial surface 271, inwardly directed hemi-circular surfaces 275 and 277, and a portion of the opening of deep slot 245.

Referring to FIG. 13, a view from the rear end 235 of the collet 231 is seen and illustrates features from outwardly to inwardly including cylindrical surface portion 237, conical portion 239, hemi cylindrical section 249, deep slots 245, hemi cylindrical section 255, hemi conical section 251, hemi conical section 257, radial surface 281, radial surface 283, and hemi-circular surfaces 275 and 277.

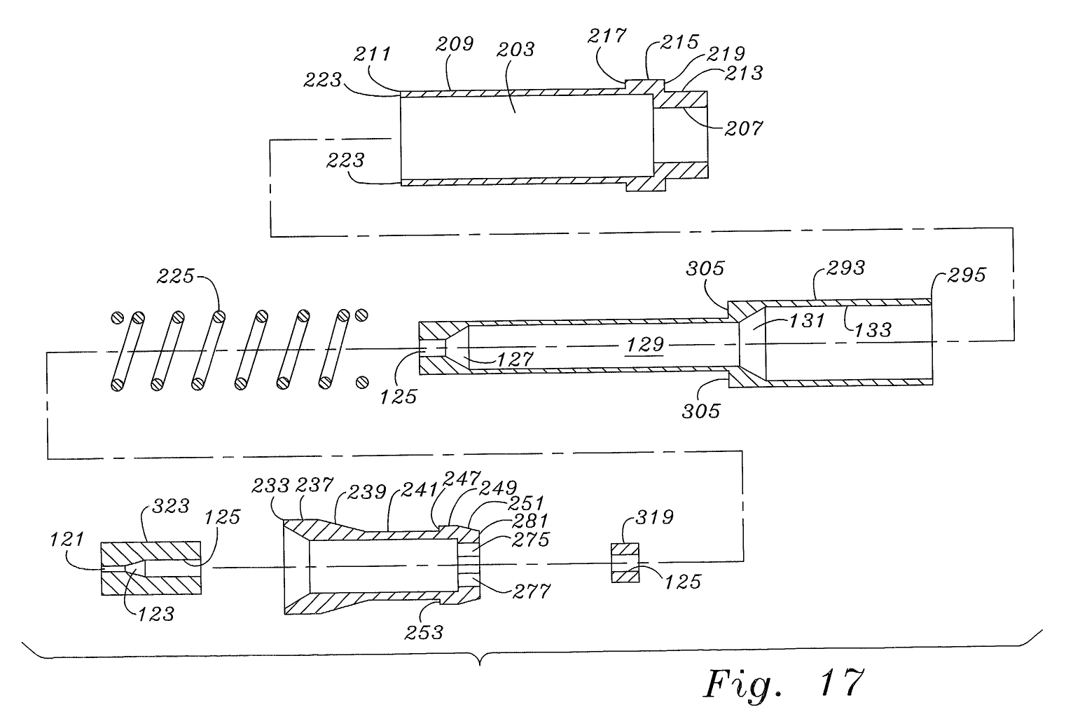

Referring to FIG. 14, an alternative version is seen as a collet 285 split into four segments, and having slots 287 which need not extend as deeply since four structures of the collet 285 are independently bendable concentrically centrally in order to provide the engagement needed.

Referring to FIG. 15, a new structure is shown in place with respect to the components seen in FIGS. 7-13. A specialized terminus body 291 has a rear cylindrical surface 293 extending forward from a rear second end 295, and a forward cylindrical section 297. The forward cylindrical section 297 has a diameter which allows entry with a close sliding fit with respect to smaller cylindrical chamber 207 of sleeve 201, and sleeve 201 is shown in position around forward cylindrical section 297.

Forward cylindrical section 297 extends completely forward to a forward first end 299, with interruption only by a circumferentially outwardly disposed groove 301, not shown in FIG. 15. As can be seen spring 225 fits in the annular space between the forward cylindrical section 297 and the main internal cylindrical bore 203 of the sleeve 201. One end of the spring 225 abuts the stepped radial surface 205, and the other end of spring 225 is free to abut the radial surfaces 281 and 283 of the collet 231.

The collet 231 is made to be urged over the first end 299 of the terminus body 291 with the first and second hemi cylindrical members 269 and 273, not show in FIG. 15, displacing away from each other in a cantilevered fashion. The axial length of the inwardly directed hemi-circular surfaces 275 and 277, shown previously in FIG. 12, are generally shorter than circumferentially outwardly disposed groove 301, not shown in FIG. 15, and may fit within it with some axial sliding play of the collet 231. The assembly of FIG. 15 may be referred to as a female force pin assembly 303. The assembly is stable as the terminus body 291 has a radial surface 305 which opposes the radial end surface 221 to limit rearward motion of the sleeve 201 with regard to the terminus body 291. Forward motion of the sleeve 201 is limited by eventual guiding forward of the spring 225 by the stepped radial surface 205 until the end of spring 225 contacts the radial surfaces 281 and 283 of the collet 231. At this point, the sleeve cannot move further forward without compressing the spring 225. Further forward sleeve movement is limited only by either the fully compressed size of the spring 225, or engagement of the edge of the abbreviated width radial surface 261 with the conical portion 239 of the collet 231.

As will be seen, even though the above discussion was taken with respect to the sleeve 201 moving forward on the terminus body 291, the actions further described will entail the stable locked position of the sleeve 201 coupled with rearward slidability of the collet 231, and terminus body 291. This very slight degree of force and axial motion will act to press two fiber optic terminations together while allowing for a backing out of the terminus body 291. Since the structure which lies beyond the rear second end 295 of the terminus body is a jacketed optical cable 103, as was seen in FIG. 1, and which is likely curving away from the terminus body 291, the slight axial movement rearward of the terminus body 291 will translate only into slight movement of the jacketed optical cable 103, and it is likely to effectively only be the portion near terminus body 291.

Female force pin assembly 303 can be thought of as a rough equivalent to the terminus body 101 seen in FIG. 1, but where the tip end, represented by first end 233 of the collet 231, is complementary to the tip end of terminus body 101. A short axial length of the internal cylindrical portion 265 accommodates a correspondingly brief axial length of forward cylindrical section 119, seen in FIG. 1, when it is brought within internal cylindrical portion 265. Outside structures which hold together the terminus body 101 and the female force pin assembly 303 will be seen in more detail below.

The internals of the specialized terminus body 291 is essentially the same as was described for terminus body 101 except for possible changes to overall length in order to fit within other bi-lateral structures to accommodate various fiber optic cable sizes and construction, in order to make-up the overall distances, as well as the presence of the circumferentially outwardly disposed groove 301 to accommodate the collet 231, and the reduced forward cylindrical section 297 to achieve fit within the sleeve 201. As such, the numbering of the internals of the terminus body 291 is the same as was the case for terminus body 101. Note that the spring 225 has a rectangular cross sectional shape.

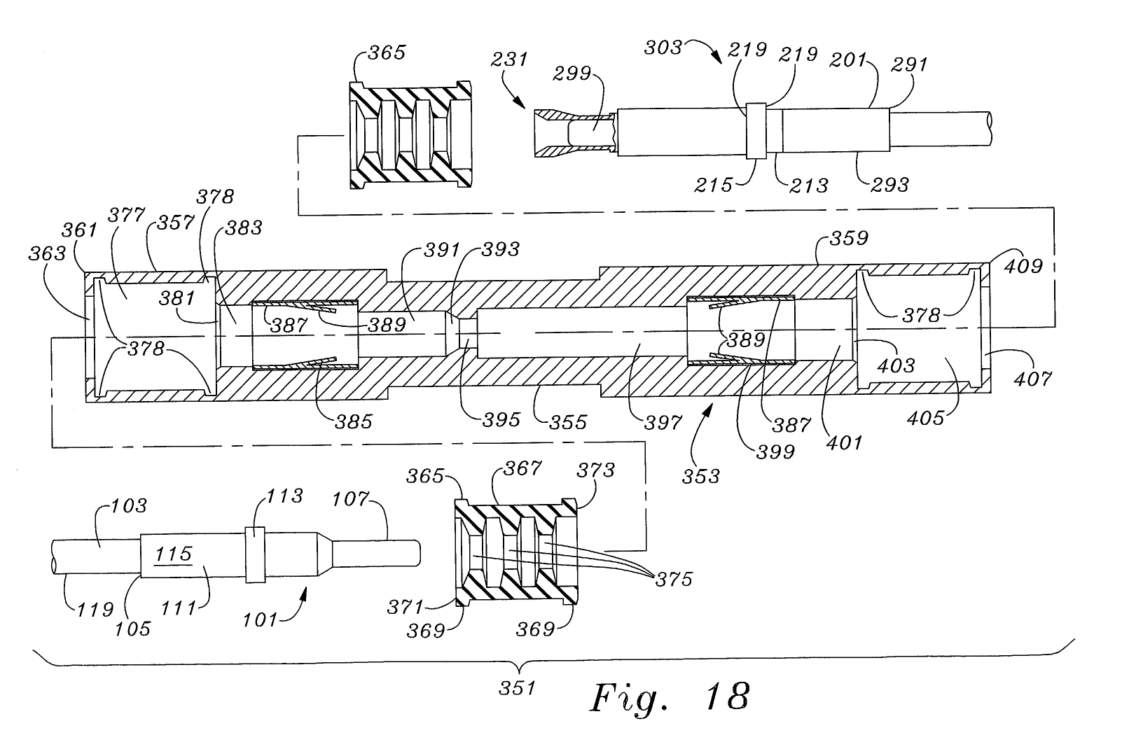

Referring to FIG. 16, an example of an alternative embodiment of a female force pin assembly is seen as a female force pin assembly 311. The collet 231 is the same, as is the sleeve 201 as in FIG. 15, but the structure includes a terminus body which is subdivided into, or constructed from three separate pieces or components. A main terminus body portion 315 includes structures such as rear cylindrical surface 293, rear second end 295, and forward cylindrical section 297, but terminates at a forward end 317.

Just forward of the forward end 317 is an intermediate block 319. Block 319 has a first surface 321 abutting forward end 317 of main terminus body portion 315. Block 319 has a second surface 323 opposite first surface 321. Adjacent the intermediate block 319 is a forward block 324 having a rear surface 325 abutting second surface 323 of intermediate block 319. Forward block 323 has a forward surface 327.

FIG. 16 illustrates an important aspect of the invention, that the boundaries of pieced components, nor the boundaries of exterior surfaces, nor the boundaries of internal surfaces and features have to any way coincide with each other.

The main terminus body portion 315 includes largest fourth bore 133, third transitional conical section 131, larger third bore 129, second transitional conical section 127, and a portion of larger second bore 125. Intermediate block 319 internal cavity contains a portion larger second bore 125. Forward block 324 includes a further portion of larger second bore 125, first transitional conical section 123, and first bore 121. The main terminus body portion 315, intermediate block 319, and forward block 324 may be joined by welding, bonding, or other technique. The configuration of FIG. 16 opens the possibility for other joinder combinations, such as one or more of collet 231, forward block 324 and intermediate block 319. Spring 225 of female force pin assembly 311 is seen has having a rounded profile.

Referring to FIG. 17, an exploded view of the female force pin assembly 311 is seen which further illustrates the separability of component parts from which the structure shown in FIG. 16 can be constructed.

Referring to FIG. 18, an exploded view of a connector assembly 351 which is shown along with the relative position of a terminus body 101 and female force pin assembly 303. Connector assembly 351 includes a connector body 353 chosen because such a body can be and is utilized to make electrical contact connections. When used for such standard connections, a male electrical pin having a general external shape similar to the shape of the terminus body 101 is used with a female electrical socket having a front opening into a cylindrical chamber sized to made a significant sliding pressure electrical contact upon entry of the male contact member. When such pin and socket contact is had within connector body 353, and in accord with the arrangement to be shown, the pin and socket are locked together. When using conductors, because the pin slides into the socket by a length of about a quarter to three-eighths of an inch, the axial “play” in this system, of even up to one sixteenth of an inch would not cause significant problems. It has been found, however that an excess dimension, or “play” of up to 0.020 inches or twenty thousandths of an inch is workable. However, for an optic system, the abutting contact at the junction of two light carrying structures is critical. As a result, to enable use of the connector body 353, the female force pin assembly 303 provides the force necessary to bring the opposing ends of both the terminus body 101 and specialized terminus body 291 together and to maintain them in an always force abutting relationship. By providing structure which permits the utilization of a connector body 353, at least one component of the system of the invention can be made non-limiting in terms of its availability. In this case, the same connector body 353 is unique in that it can be used for both fiber optics and electrical contact connections. When used as an electrical connection, the milivolt drop across connector body 353 will be less than an equal length of equivalent copper conductor.

From an external perspective, connector body 353, has a third, central reduced diameter portion 355 bounded by a first portion 357 and a second portion 359. Second portion 359 is slightly axially longer than first portion 357 to accommodate longer specialized terminus body 291, just as it accommodates a longer female socket in electrical contact use. Also, the length prevents female force pin assembly 303 from being inadvertently inserted into first portion 357. This prevents two female force pin assemblies 303 from being installed in the wrong chamber or two terminus bodies 101 from being installed in the incorrect chamber.

Beginning at the lower left of FIG. 18, the terminus body 101 with its trailing optical cable 103 will be inserted at a first end 361, through a first opening 363 containing a moisture seal grommet and vibration dampener 365. The moisture seal grommet and vibration dampner 365 is piston shaped having a main cylindrical extent 367 with a pair of oppositely located lands 369 at opposite ends, including first end 371 and second end 373. Inside the moisture seal grommet and vibration dampner 365 are three annular baffles 375 which form a moisture seal and cable support with respect to areas of the cable 103. The terminus body 101 passes through the three annular baffles 375 as it enters the connector body 353. The moisture seal grommet and vibration dampner 365 is sized to fit within a grommet cavity or simply a cavity 377 of the connector body 353, and in such a way as to permit the terminus body 101 to fit into place and be removed from its position without disturbing its fit within the cavity 377. A locking groove 378 is shown as providing a complementary structure for engaging lands 369 on the grommet 365. The baffles 375 do not touch terminus body 101 or rear cylindrical section 111 when fully inserted. The baffles do have different internal diameters to accommodate different cable outer diameters for sealing and dampening and for ease of insertion and removal with the removal/insertion tool.

The internal details of the connector body 353 include, beyond the first opening 363 and cavity 377, a short beveled section 381 leading to an entry bore 383, and then to a sized locking ring chamber 385. Within the locking ring chamber 385, a locking ring 387 having inwardly bent locking fingers 389. The locking ring 387 is usually a circumferentially non-continuously extending hollow annular piston which has ends which can be urged to a touching relationship to reduce the resting diameter enough to pass through the entry bore 383. Once inside the locking ring chamber 385, the locking ring 387 will again expand to “snap fit” in a very stable configuration within the locking ring chamber 385. The locking ring 113 of terminus body 101 locks, by a snapping action, forward of the inwardly bent locking fingers 389. The chambers 385, 391 and 395 form a geometric plain that provides contricity and stability for terminus body 101 as well as copper terminations.

Beyond the locking ring chamber 385 is a cylindrical section chamber 391 for accommodating the cylindrical section 115 of the terminus body 101. Beyond the cylindrical section chamber 391 is a conical section chamber 393 for accommodating the conic section 117 of the terminus body 101. Beyond the conical section chamber 393 a short length of a cylindrical section chamber 395 provides the smallest internal diameter and is sized for accommodating the forward cylindrical section 119 of the terminus body 101. It is understood that the short length of a cylindrical section chamber 395 is a structure which orients and sets one end of the connector body 353 as being female and one end as being male. If section chamber 393, which is shown as a conical section which aids the forward cylindrical section 119 were to enter the short length of a cylindrical section chamber 395, and if short length of a cylindrical section chamber 395 were removed, this would allow the female force pin assembly 303 to be inserted and locked into position.

Generally speaking, if the terminus body 101 were to move forward, it would be stopped by a radial boundary surface defining the locking ring chamber 385 located to the left of the cylindrical section chamber 391. The provision of a stop provided by the cylindrical section chamber 395 provide stability both in its axial travel and in its centering action. A straight bore between the locking rings 389 is possible, but at the expense of the more desirable centering and axial limiting features.

Beyond the short length of cylindrical section chamber 395 is a main interface chamber 397 in which the fiber to fiber contact, and electrical contact if desired, will take place. For the structures beyond the main interface chamber 397, similar structures shown with respect to the first end 361 are seen as a locking ring chamber 399, entry bore 401, a short beveled section 403 and thence to a cavity 405, second opening 407 and terminating at a second end 409.

An identical moisture seal grommet and vibration dampner 365 is shown which will fit within the cavity 405. The female force pin assembly 303 is shown with its collet 231 provided to guide the first end 107 of terminus body 101 into opposing force urged contact with the forward first end 299 of the specialized terminus body 291. The order of entry of the terminus body 101 and female force pin assembly 303 into the connector body 353, as well as which of the terminus body and female force pin assembly 303 go into which end 361, 409 of the connector body 353 are as follows. The female force pin assembly 303 should ideally be inserted into the connector body 353 first and at the second end 409 and into the relatively axially longer second portion 359, although the terminus body 101 could have been inserted first. This explanation is for illustrating the action present, the interrelation between the parts, and is explained with regard to one order of insertion for clarity. Without the presence of the first end 107 within the main interface chamber 397, the collet 231 may travel completely within the main interface chamber 397 to a position adjacent the short length of a cylindrical section chamber 395, to insure that the inwardly bent locking fingers 389 can fully engage the radial surface 219 on the radially projecting land section 215 to hold the specialized terminus body 291 securely within the connector body 353.

Thereafter, as the terminus body 101 is inserted, and as the first end 107 extends past the short length of a cylindrical section chamber 395 and into the collet 231 to abut the forward first end 299, the forward first end 299 will move rearwardly to push the specialized terminus body 291 rearwardly while the sleeve 201 is held in place by the inwardly bent locking fingers 389.

Referring to FIG. 19, the assembled and connected assembly within the connector body 353 is seen. Further to the procedure described with respect to FIG. 16, note that the amount by which the axial length of the circumferentially outwardly disposed groove 301, seen in FIG. 15, exceeds the axial length of the inwardly directed hemi-circular surfaces 275 and 277, as was seen in FIG. 11, this is the amount in which the forward first end 299 of the specialized terminus body 291, which was seen in FIG. 14, will be displaced toward the sleeve 201 before any displacement of the collet 231 will begin. If further displacement of the collet 231 away from the position adjacent the short length of a cylindrical section chamber 395 occurs, it should be minimal, and only sufficient to insure that adequate force contact of the forward cylindrical section 119 and against the forward first end 299 occurs.

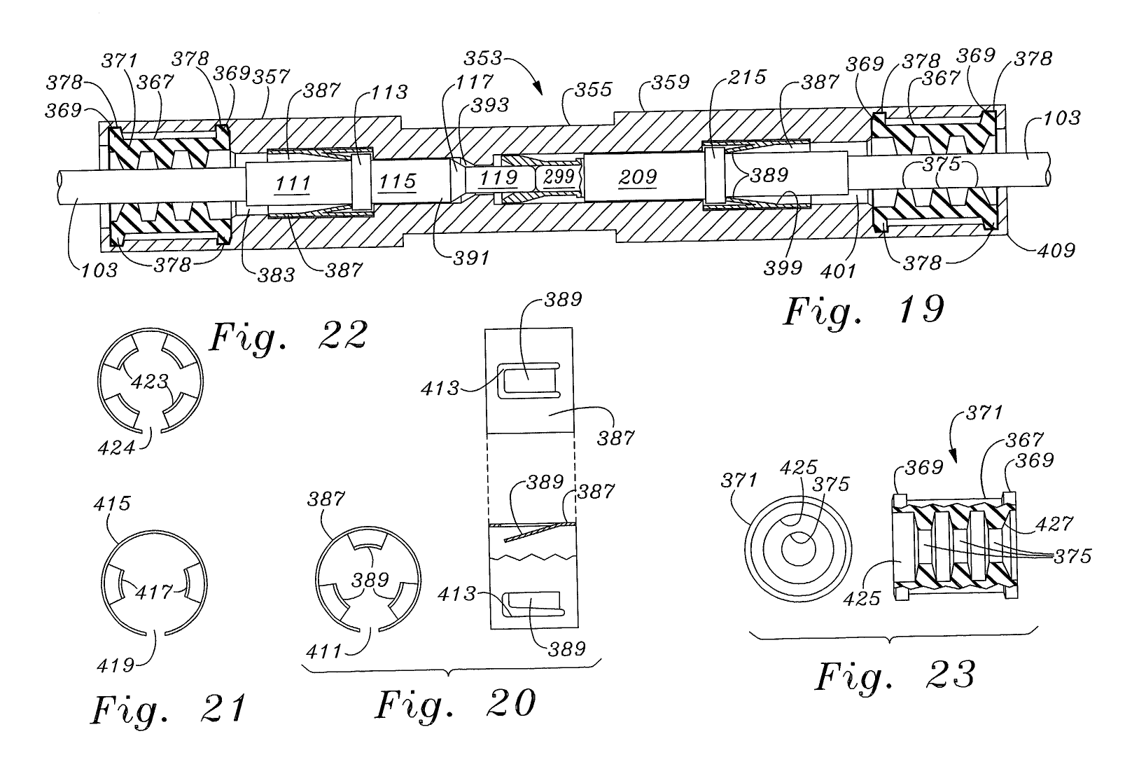

Referring to FIG. 20, a multi view of the locking ring 387 reveals the details thereof. A gap 411 is provided in the locking ring's quiescent state so that it may be closed to effectively reduce the radius of the locking ring 387 so that it will fit past the entry bores 383 and 401 for seating within the locking ring chambers 385 and 399, seen in FIG. 18. The inwardly bent locking fingers 389 can be seen as being punched from a larger surrounding aperture 413. The locking ring 387 has three inwardly bent locking fingers 389.

Referring to FIG. 21, a locking ring 415 has a pair of oppositely oriented inwardly bent locking fingers 417 which are symmetrically located on either side of a gap 419. Referring to FIG. 22 a locking ring 421 has a set of four, generally opposing, but not necessarily opposite inwardly bent locking fingers 423 which are symmetrically located on either side of a gap 424. Referring to FIG. 23, an end and sectional view of the moisture seal grommet and vibrational dampener 371 is seen looking into a main chamber 425. An abbreviated size channel 427 is also seen in section.

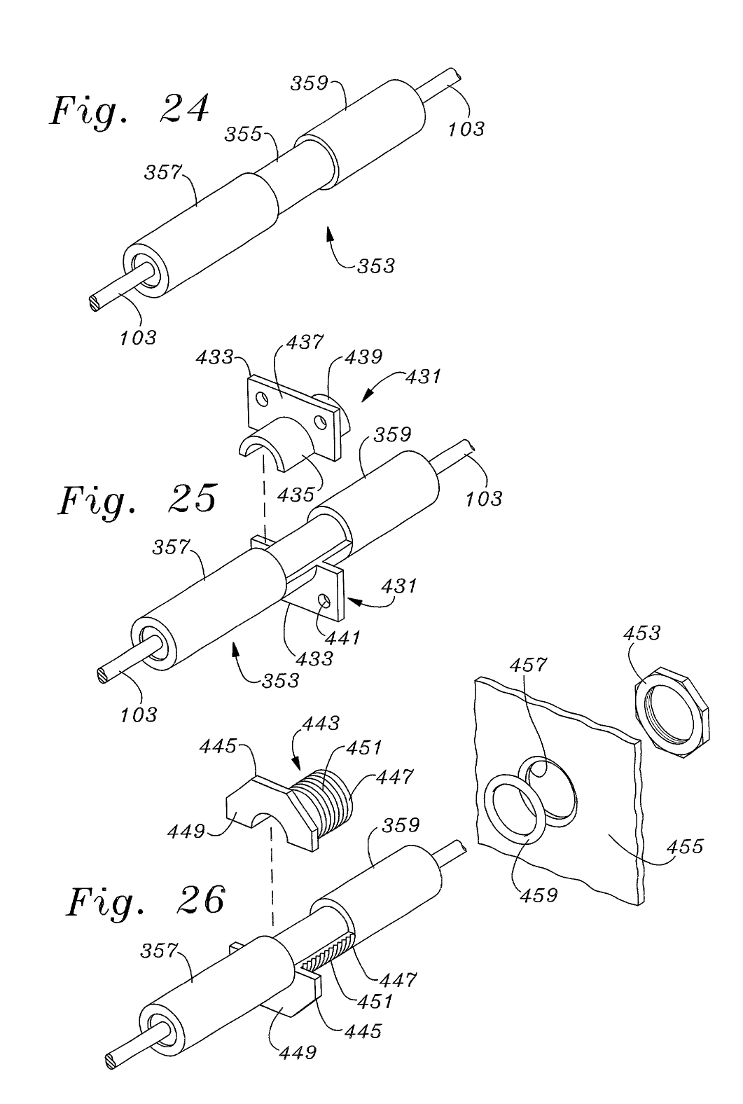

Referring to FIG. 24, a perspective view of the connector body 353 with the optical cable 103 protruding from both ends is seen. This configuration is what will be seen where the connector body 353 is used as a loose single in-line connector optically or electrically. However, the connector body 353 can also be used with other hardware in a variety of situations.

Referring to FIG. 25, the connector body 353 is seen in conjunction with a split plate support 431 having a pair of identical half plates 433. Each half plate 433 has a first hemi cylindrical portion 435 extending from one side of a plate portion 437 and a second hemi cylindrical portion 439 extending from the other side of a plate portion 437. When two half plates 433 are brought together, the hemi cylindrical portions 435 form a cylinder which fits neatly within the third central reduced diameter portion 355 which enables the connector body 353 to be grasped in a stable manner which not only supports the connector body 353 with regard to significant support along its length, but also completely stabilizes it against axial movement. When it is in position, the optical or electrical cable 103 can be decoupled from and re-coupled to the connector body by the use of a tool axially inserted between the inwardly bent locking fingers 389, seen in FIG. 20, to urge them away with engagement with the projecting land section 113 or 215, as seen in FIG. 18. The split plate support 431 is typically used with a mounting aperture of greater diameter than the outside diameter of the cylinder formed by the joinder of two opposite hemi cylindrical portions 435 and 439, with anchoring rivets or screws extended through apertures 441.

Referring to FIG. 26, a split sleeve 443 including two elongated split threaded hemi sleeves 445 each having a half cylindrical threaded portion 447, and a hex shaped flange 449. The half cylindrical threaded portions 447, when joined, for a cylindrical shape in which threads 451 extend just enough above both of the first portion 357 and second portion 359 in order that a hex-nut 453 can be moved over either the first portion 357 or second portion 359 and still be enabled to engage the threads 451. This structure is used to mount the connector body 353 with respect to a thin wall 455 having an aperture 457, and possibly with the addition of a toroidally shaped “o” ring 459.

The connector body 353 is particularly advantageous for use as a single connector, especially as it can be pre-assembled and utilized in the field in multiple numbers, etc. However, where multiple terminations are desired, the close packing or ganging of the connector bodies 353 would be unwieldy. Further, since multiple connects can be stabilized more easily due to the naturally occurring wider shape of the connectors, the complex bore shape seen with regard to a single connector body 353 can be accomplished in stages or axial layers to facilitate the formation of boundaries having different internal diameters. Single connector body 353 may be available in a variety of sizes, and currently there are three.

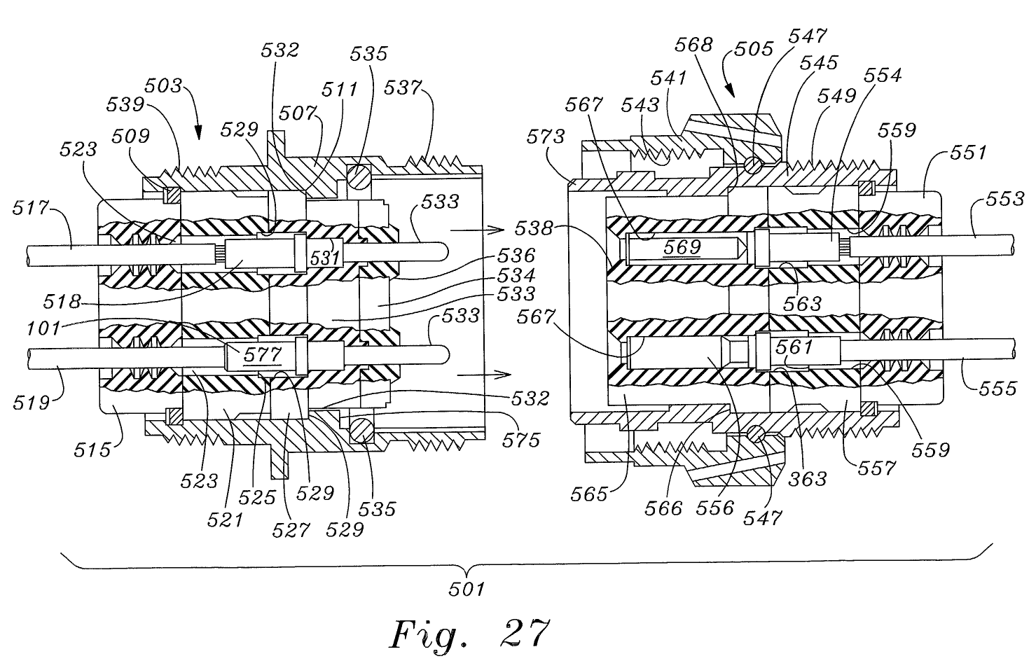

Referring to FIG. 27, one of numerous possible configurations of a multi-termination connector set 501 which includes a male connector 503 and a female connector 505. To illustrate the deviations from a single termination, connectors 503 and 505 may be set up to provide electrical termination, optical termination or a combination of both within the same set 501. One termination each in each category will be presented.

Male connector 503 includes a shell 507 having a rear locking ring 509 and a front locking structure 511 for holding in sandwich configuration a back sealing section 515 having an internal sealing structure shown surrounding conducting service line 517 leading to a conducting terminus body 518 and fiber optic service line 519 leading to a fiber optic terminus body 101.

Forward of section 515 is a section 521 which provides additional internal bores 523 having radial internal step transitions 525. Any time that stepped transitions can be provided closer to the surface of a section, production and assembly is aided. A section 527 is adjacent section 521 and provides the bulk of a number of locking ring chambers 529, as well as a series of stepped cylindrical section chambers 531. The section 527 has an internally stepped radial reduction 529 for engaging each terminus body, of any type, introduced into it. At the lower section 527 has an outer periphery which engages inward stepped structure 532. The last layer before exposure of a series of forward cylindrical sections 533 of the terminus bodies, including terminus bodies 101 and 518, is a sealing layer 534 which closely surrounds same. Sealing layer 534 is preferably the most flexible and conforming, as compared to layers 527 and 521. A sealing “o” ring 535 is also seen which seals on 573. A boss 536 extends forward for the purpose of providing additional sealing utilizing an opposing structure.

The housing shell 507 may have threads, including forward threads 537 for engagement with the threads of another connector. In addition, a bevel structure 538 is shown opposite the boss structure 536 for assisting in sealing out debris and moisture. The angle of the boss 536 will engage and mutually deform with the bevel structure 538 to form a seal. A set of rearward threads 539 to insure mechanical connectivity and provision of further covering protection, and environmental seal respectively, with an optional cover structure (not shown).

The female connector 505 has a coupling nut system 541 having circumferentially inwardly directed threads 543. The coupling nut system 541 is rotatably connected to a main housing 545 by a sealing member or bearing 547. The main housing 545 may have rear external threads 549. The main housing 545 may also have sections such as back sealing section 551 having an internal sealing structure shown surrounding conducting service line 553, which terminates in a female conductive socket 554, and fiber optic service line 555 which terminates at a female force pin assembly 556.

Forward of section 551 is a section 557 which provides additional internal bores 559 having radial step transitions 561 and which provides the bulk of a number of locking ring chambers 563. Any time that stepped transitions can be provided closer to the surface of a section, production and assembly is aided. A section 565 is adjacent section 557 and has a stepped surface 566. Section 565 also has cylindrical section chambers 567. Housing 545 has an inward step 568 for engaging the stepped surface 566. Section chamber 567 contains both a female conductive socket 554 as well as a female force pin assembly 556. For maximum sealing the female connector 505 has a forward rim 573 which fits within a forward rim 575 of the male connector 503. The terminus body 101 is and mates with terminus 561.

Referring to FIG. 28, a closeup side sectional view of the terminus body 577 is seen. The terminus body 577, may be either a field finish termination body 101 as seen in FIG. 1, or a factory completed termination structure. The external features are largely the same as was the case for terminus body 101 of FIG. 1. Two differences include an enlarged and combined first and second bores 121 and 125 to form a combined first and second bore 579 to accommodate a precision insert 581, and the presence of the epoxy preform 583 seen in the third larger bore 129, which was also seen in FIG. 2. Further, the length of the forward cylindrical section 119 may be longer. Again, the epoxy preform 583 may also have a preformed epoxy construction as was the case seen in FIG. 2, and which foams or expands under heat to a final form dictated by the internal shape into which it comes into contact.

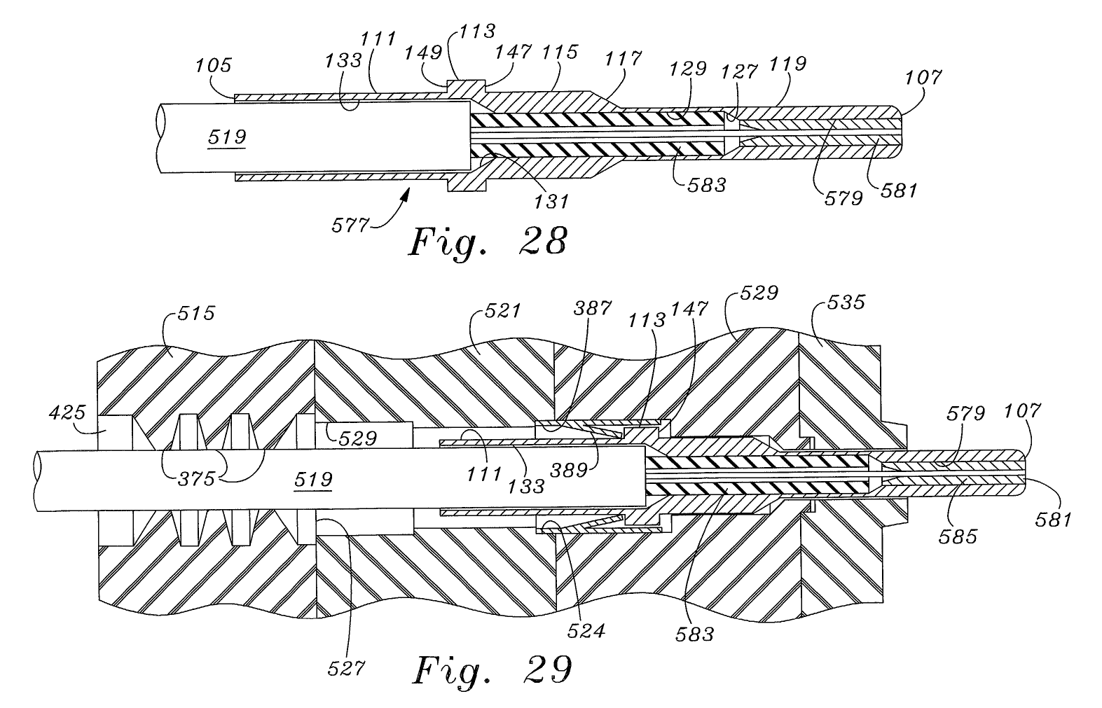

Referring to FIG. 29, a closeup view enables a numbering of the smaller structures similar to that seen in FIG. 16. Referring to FIG. 27, a closeup side sectional view of the terminus body 577 is seen. The terminus body 577, may be either a field finish termination body 101 as seen in FIG. 2, or a factory completed termination structure. The external features are largely the same as was the case for terminus body 101 of FIG. 2. Again, two differences include an enlarged and combined first and second bores 121 and 125 to form a combined first and second bore 583 to accommodate a precision insert 585.

Referring to FIG. 30, a side sectional view of specialized terminus body 291 but having a guide structure 585 to illustrate the guide structure 585 would function with structures other than those seen in FIGS. 15 and 16. The operation in terms of connectivity is the same as for the structures of FIGS. 15 and 16.

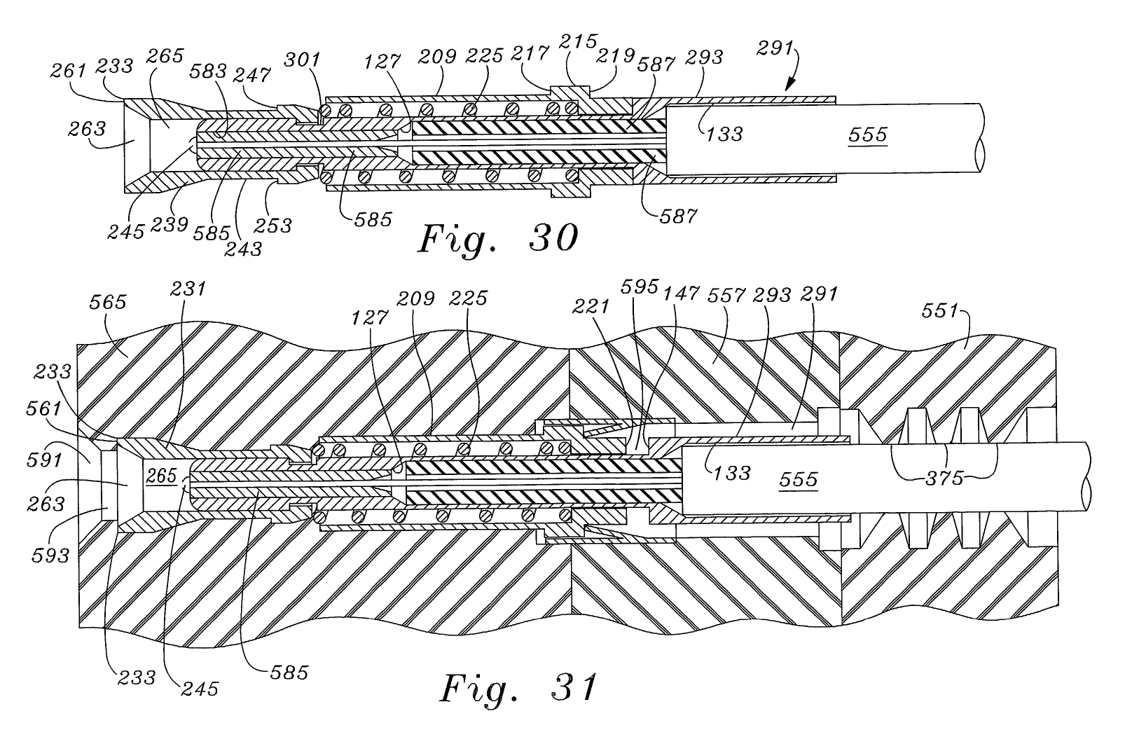

Referring to FIG. 31, an enlarged view reveals many of the similar structures which were seen in FIG. 27. A conical entrance 591 is seen leading to an abbreviated length close tolerance entry bore which also provides a stop for the first end 233 of the collet 231. FIG. 31 also illustrates the action of the specialized terminus body 291 in a position where the specialized terminus body 291 (which was identified as the whole structure seen in FIG. 30) is seen to be moved rearward to create a gap 595 between radial surface 221 and the forward or first radial surface 147 of the body 291.

In the Figures seen thus far, the structures shown have been appropriate to provide field terminations and splicing, as well as multi-point terminations in contact housings and pin and socket structures which can provide additional continuation structures in order to transmit/receive a fiber optical signal through a system of which it is a part. Since most fiber optical signals are either generated by or utilized by standard analog or digital circuitry, the situs of the optical-electrical interface is one of the most important points in the system. Further, the termination shown herein is compatible with the terminations shown in the previous Figures. As a result, the system of the invention can experience even further facilitation and can accommodate other sizes of optical or electrical cable.

Referring to FIG. 32, an end view of a termination block 601 illustrates a rectangular shape in order to give some spatial variation in mounting. Mounting on its wide surfaces 603 gives more stability. FIG. 32 illustrates an accommodation space 607 having a tab groove 609 to accommodate an orientation tab which is often found in the light generating or detecting packaging. This packaging is also referred to as a “can”. At the center of the accommodation space 607 is a bore 611 through which light is received or transmitted.

Referring to FIG. 33, a side view of the termination block 601 illustrates a pair of offset bores 613 for securing the termination block 601 to a circuit board or the like. The termination block 601 has a block portion 615 and a cylindrical portion 617, which is shown as being slightly flattened along one strip 619 one side for a little increased stability along that side.

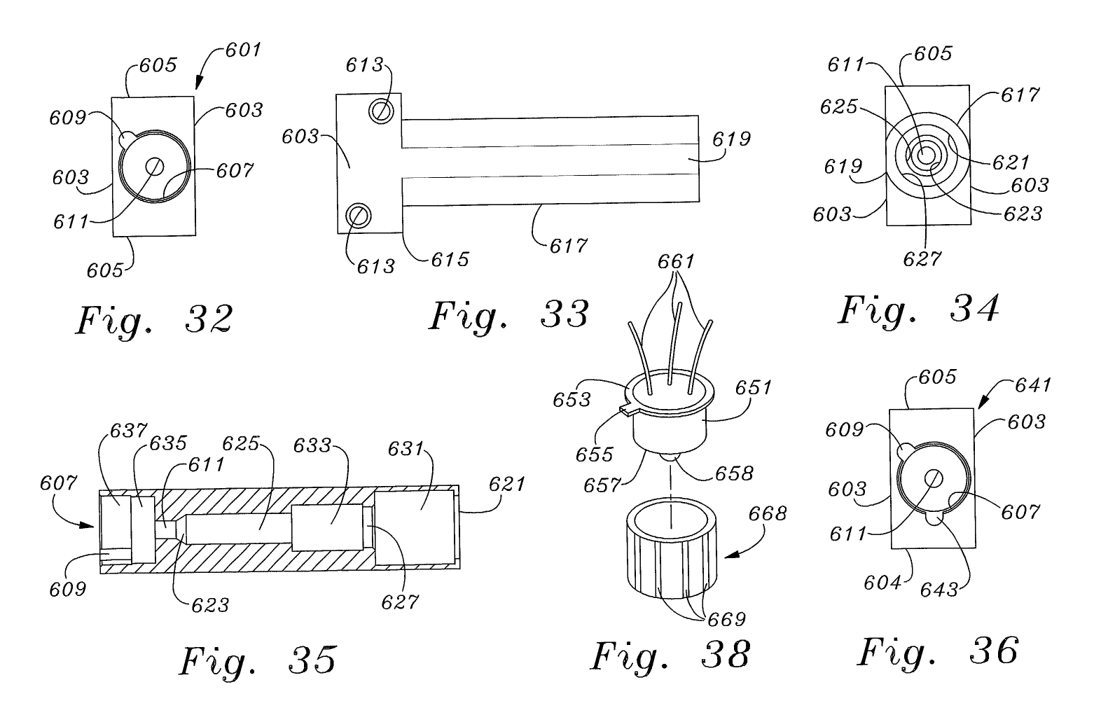

Referring to FIG. 34 an end view looking into the space where a terminus body, such as terminus body 101, may be inserted to either provide an optic termination of propagation or an optic beginning of propagation, or both depending upon whether the electrical component is a detector, transmitter, or combination transceiver. Structures seen include first opening 621. a conical section 623, cylindrical section chamber 625 is seen, as is an intermediate cylindrical section 627.

Referring to FIG. 35, a side sectional view better illustrates the structures seen in FIG. 34. A cavity lies adjacent first opening 621 for accommodating and fitting a moisture seal grommet and vibrational dampener 365 seen in FIG. 18. Next is the intermediate cylindrical section 627, followed by a locking ring chamber 633. Next follows the preferably close tolerance cylindrical section chamber 625, followed by the conical section 623, and then the preferably close toleranced bore 611. Beyond the bore 611 is the relatively spacious accommodation space 607 within which will sit the circuit packaging. As will be seen, the circuit packaging is usually “can” shaped with a lower circumferentially protruding rim. As can be seen in FIG. 35, the accommodation space 607 is really subdivided into three spaces, including the tab groove 609, the other two spaces being a slightly smaller diameter bore 635 and a relatively larger diameter bore 637 to accommodate the “can” lower circumferentially protruding rim to insure that the “can” is extended as far toward the short length of bore 611 as is possible.

Referring to FIG. 36, a variation on the termination block 601 is seen as a termination block 641, and is different in that it contains an additional tab groove 643 in addition to tab groove 609, to enable circuit components to be mounted in one of at least two (or more if additional accommodating structure is provided) configurations.

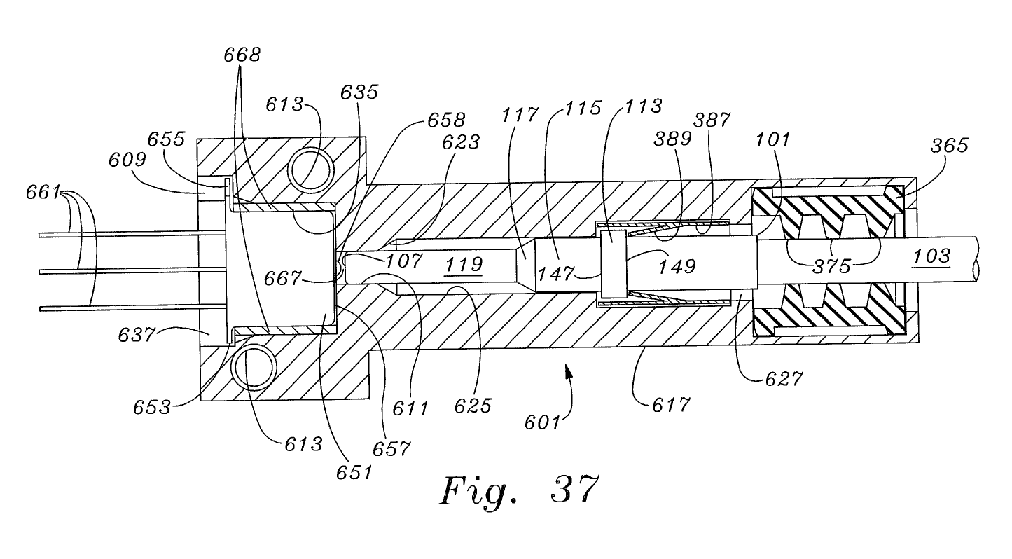

Referring to FIG. 37, a section view with the components previously described assembled into a working package is shown. An electronics package or “can” 651 has a protruding rim 653 which fits through the relatively larger diameter bore 637 to enable a main extent of the can 651 to fit into the slightly smaller diameter bore 635 to place it as close as possible to the bore 611 as possible. The can rim 653 has a tab 655 which is further accommodated by tab groove 609 which also registers the can 651. A top 657 of the can 651 contains an optically active element 658, either receiving or transmitting, and which is in optical alignment with the bore 611. Extending to the left of can 651 are a series of three leads 661 which will be used to connect to circuitry on a circuit board or other structure. The termination block 601 can be incorporated into other structures to provide integrated packages of all kinds.

The moisture seal grommet and vibration dampener 365 is seen in place, as a terminus body 101 as seen in FIGS. 1 and 3 is shown as inserted into the termination block 601. Note that the end 107 of the forward cylindrical section 119 is extremely close to the top 657 of the can 651. A gap 667 of small dimension may be allowed to remain, since a small gap or mismatch between the source or detector can normally be tolerated at the ultimate terminations. This smallness also prevents the optical fiber from being in contact with “can” 651 so that if vibration or shock is present, any relative movement or motion will not crack or shatter the optical fiber.

There are many ways in which the electronics package or “can” 651 can be centered, secured, and otherwise accurately and securely placed within its accommodation space 607. There are many past present and future methods contemplated to be used in this process. However, one method which has been found to work well is the use, as is shown in FIG. 37, and in more detail in FIG. 38, of a thin ring 668 having a series of internal or external or both of crushable rings 669. The crush ability should be radially equilateral to provide a centering action as well as a friction gripping action as crushing occurs. The use of such a pre-toleranced structure eliminates any dangers and complications which may result from the use of solvents, inexact application of glues, and liquid run-on to the area which would obscure the optical path. Other styles of crushable rings 668 may be utilized. An assembler need only fit the ring 668 onto the can 651 or within the accommodation space 607, followed by the step of either fitting the can 651 with ring 668 attached into the accommodation space 607 or fitting the can 651 into the ring 688 within the accommodation space 607, respectively. The use of the ring 688 permits interchange of the can 651 with a fresh ring 668. Of course, a can 651 could be made with crushable ribs, and the accommodation space 607 could have such ribs formed within it, but the ability to use a fresh ring when interchanging can 651 is especially useful in more expensive systems where interchange is more desired than total unit replace ability.

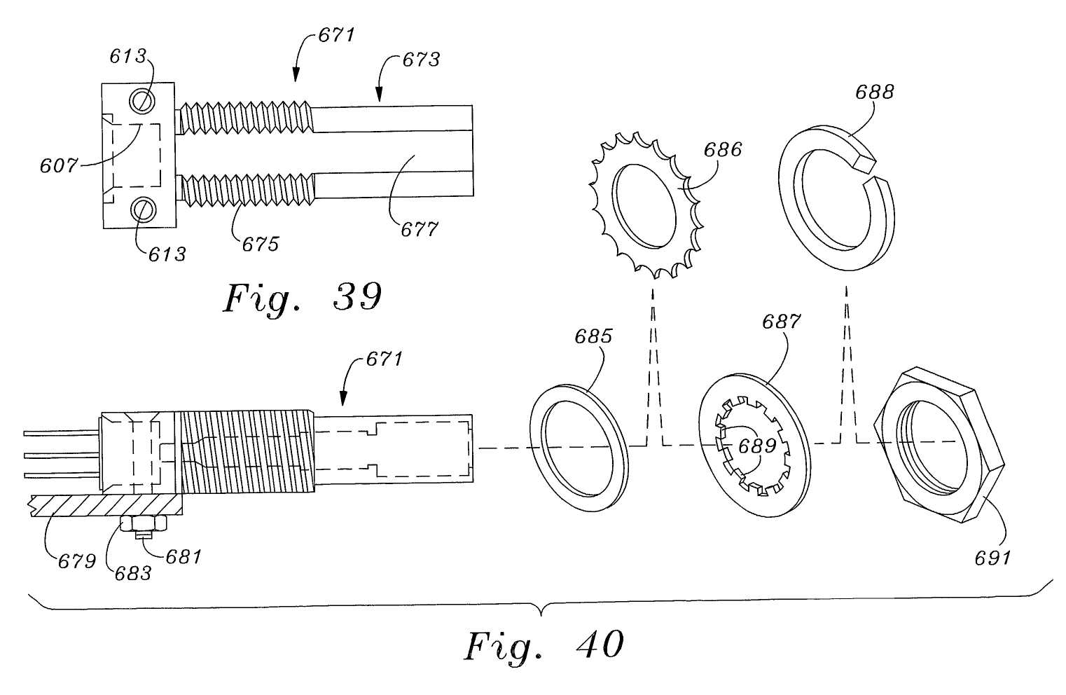

Referring to FIG. 39, a variation of the design of the termination block 601 is seen as a termination block 671. Termination block 671 differs only in that the cylindrical portion 617 seen in FIG. 33, is replaced by a cylindrical portion 673 having a threaded portion 675 and a smooth portion 677. The threaded portion 675 can be utilized with a hex nut to mount the termination block 671 with respect to an aperture, as well as to an circuit board. Note also that the bores 613 may be in this case evenly oriented. Accommodation space 607 is seen in dashed line format.

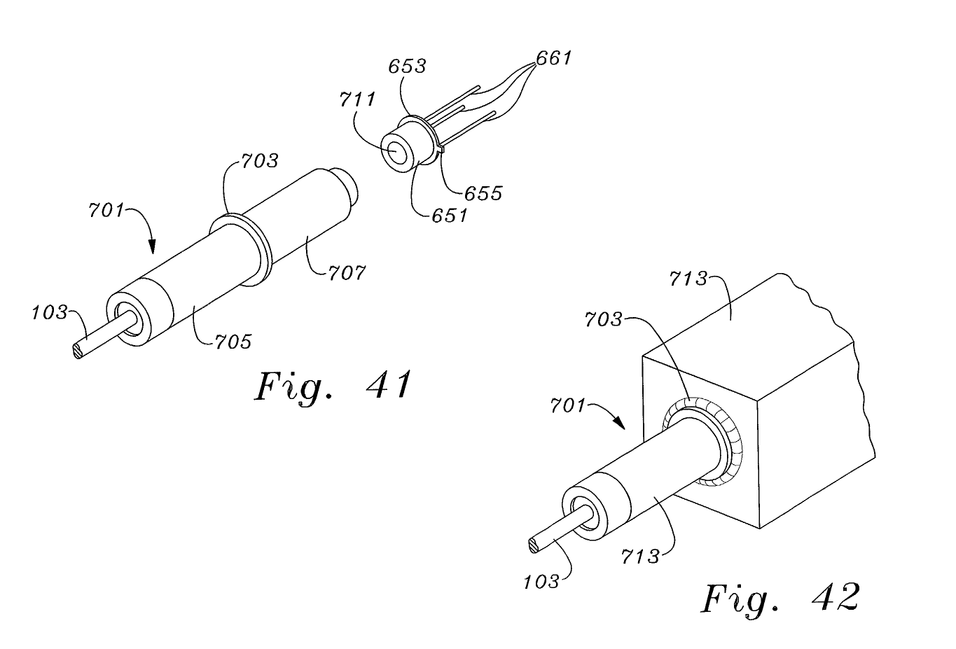

Referring to FIG. 40, the termination block 671 is shown mounted on a circuit board 679 and secured by a bolt 681 and nut 683. Termination block 671 is shown extending beyond the end of the circuit board to illustrate that it may be used to also mount with respect to a wall. Washers may be used, including a flat washer 685, external lock washer 686, an internal lock washer 687 or a split lock washer 688, preferably secured with a nut 691. These will all provide fixation of the termination block 671, especially with respect to a wall or other mechanically secure structure.

Referring to FIG. 41, and in a variation of the termination block 601, a structure is shown as a receptacle 701 accepts an internally secured and hermetically sealed terminus body 101 with an optical cable 103 extending therefrom. A flange or ring 703 can be used for stabilization or as a welding or solder flange other support mounting, and generally divides the receptacle 701 generally into a first terminus body 101 receptacle portion 705 and a second electronic component accommodation section 707 having internals as are seen within cylindrical portion 617 of FIG. 33. Further, the electronics package 651 can be seen as including a centrally mounted optically transmissive or receptive element 711. The electronics package 651 may also typically be a laser, light emitting diode or other component. A configuration illustrating the utilization of the receptacle 701 is seen in FIG. 42 in which the receptacle 701 is inserted up to the ring 703 into a fiber optic switch, sensor or other hermetically sealed component 713. The ring sets the extent of insertion and permits safe, secure and rapid hookup. Fixation can be by gluing, soldering, welding, or other form of fixation and may involve guiding internals within component 713 for safe, rapid fixation. As can be seen, flange or ring 703 can be solder or electronically beam welded to the forward end of component 713 to provide a hermetically sealed package.

The present invention has been stated in terms of a stable, standard and fully integrated, and moreover fool-proof termination system amenable to safe, secure, and easy installation by technicians in the field or in the shop. The structures of the invention can be applied to any instance where secure and reliable interconnects are needed.

Although the invention has been derived with reference to particular illustrative embodiments thereof, many changes and modifications of the invention may become apparent to those skilled in the art without departing from the spirit and scope of the invention. Therefore, included within the patent warranted hereon are all such changes and modifications as may reasonably and properly be included within the scope of this contribution to the art.

What is claimed:

1. A fiber optic terminus body comprising:
a housing having an exterior and an interior, said exterior having a rear cylindrical section nearest a first end of said housing and a forward cylindrical section nearest a second end of said housing, said first end of said housing having a first opening into said interior for accepting and supporting a length of a fiber optic cable as it extends through said first opening and away from said housing, said second end of said housing having a second opening into said interior for transmitting light from said fiber optic cable, and an engagement structure on said exterior of said housing for preventing movement of said housing in a direction toward said first end of said housing.

2. The fiber optic terminus body as recited in claim 1 wherein said rear cylindrical section is larger than said forward cylindrical section.

3. The fiber optic terminus body as recited in claim 1 wherein said engagement structure is a radial surface adjacent at least one of said rear and said forward cylindrical sections.

4. The fiber optic terminus body as recited in claim 1 wherein said interior of said housing includes at least a first bore adjacent said first end of said housing and at least a second bore adjacent said second end of said housing and in communication with said first bore and wherein said second bore is smaller than said first bore.

5. The fiber optic terminus body as recited in claim 1 wherein said interior of said housing includes a conical transition section between said at least a first bore and said at least a second bore.

6. The fiber optic terminus body as recited in claim 4 wherein said interior of said housing includes at least a third bore between said at least a first bore and said at least a second bore.

7. The fiber optic terminus body as recited in claim 1 wherein at least one of said at least a first bore, at least a second bore and at least a third bore contains said preform in sufficient quantity to expand beyond said least one of said at least a first bore, at least a second bore and at least a third bore in which it is contained.

8. A fiber optic terminus body assembly comprising:
a housing having an exterior and an interior, said exterior having a rear cylindrical section nearest a first end of said housing and a forward cylindrical section nearest a second end of said housing, said first end of said housing having a first opening into said interior for accepting and supporting a length of a fiber optic cable as it extends through said first opening and away from said housing, said second end of said housing having a second opening into said interior for transmitting light from said fiber optic cable;
a sleeve having a through bore axially slidable over said forward cylindrical section of said housing;
a force structure engaging said housing and said sleeve for resiliently urging said sleeve toward said first end of said housing; said sleeve having an engagement structure on said exterior of said sleeve for preventing movement of said sleeve in a direction toward said first end of said housing.

9. The fiber optic terminus body as recited in claim 8 wherein said housing includes a depression and further comprising a collet having a through bore for fitting at least partially over said housing and at least one concentrically inwardly projecting member for engaging said depression and for engaging said force structure.

10. The fiber optic terminus body as recited in claim 9 wherein said at least one concentrically inwardly projecting member of said collet is smaller than said depression in the axial direction to enable said collet to move axially with respect to said housing.

11. The fiber optic terminus body as recited in claim 9 wherein force against said second end of said housing with respect to said sleeve enables axial movement of said housing with respect to said sleeve and against said force structure.

12. The fiber optic terminus body as recited in claim 9 wherein said collet, upon further application of force against said second end of said housing with respect to said sleeve, is sized to permit axial movement of said collet at least partially into said sleeve.

13. A connector assembly for providing an interconnection for terminus bodies and terminus body assemblies comprising:
an interconnect housing having a first open end and a second open end, an exterior and an interior, said interior having a chamber extending throughout said interior of said connector assembly and between said first and said second open ends, said first open end for accepting said terminus body only into said first open end of said interconnect housing and said second open end for accepting said terminus body assembly only into said second open end of said interconnect housing while providing inherent alignement of said terminus body and said terminus body assembly with respect to each other, and communication within said chamber, said chamber further including at least a first locking ring chamber and a second locking ring chamber located closer to said second end of said interconnect housing than said first locking ring chamber;
a first locking ring having a generally cylindrically shaped body with at least one concentrically inwardly disposed locking finger directed away from said first end of said interconnect housing, and located within said first locking ring chamber; and
a second locking ring having a generally cylindrically shaped body with at least one concentrically inwardly disposed locking finger directed away from said second end of said interconnect housing, and located within said second locking ring chamber.

14. The connector assembly as recited in claim 13 and further comprising at least one grommet located between at least one of said first locking ring chamber and said first open end of said interconnect housing and said second locking ring chamber and said second open end of said interconnect housing.

15. The connector assembly as recited in claim 14 wherein said at least one grommet sits at least partially within a cavity.

16. The connector assembly as recited in claim 14 wherein said grommet further comprises an annularly cylindrical shape having a through bore containing a plurality of annular baffles located therein.

17. The connector assembly as recited in claim 13 wherein said first and second locking rings each having a generally cylindrically shaped body with at least a plurality of concentrically inwardly disposed locking fingers.

18. The connector assembly as recited in claim 13 wherein said first and second locking rings generally cylindrically shaped body is interrupted by an axially extending gap to enable each of said first and said second locking rings to reduce its effective diameter to facilitate placement within said connector assembly.

19. The connector assembly as recited in claim 13 wherein said interconnect housing has a depression along its exterior length and further comprising a plate support, engageable with said depression, for mounting said connector assembly with respect to a support structure.

20. A multi-pin connector assembly for providing a multiple interconnection for terminus bodies and terminus body assemblies comprising:
a first interconnect housing having at least a first section having a first plurality of first chambers extending generally adjacent each other throughout said at least a first section, each of said first plurality of first chambers having a first open end and a second open end, and an interior, each of said first plurality of first chambers for accepting at least one of said terminus body and said terminus body assembly through said first open end such that said first interconnect housing will be utilizable as a multi-contact male connector against a complementary second interconnect housing utilizable as a multi-contact female connector, each of said first plurality of said first chambers including at least a first plurality of locking rings for holding an associated said at least one of said terminus body and said terminus body assembly in a position to resist backing out of each of said associated said at least one of said terminus body and said terminus body assembly away from said second end of said first plurality of first chambers, and including structure for fixing said first interconnect housing to said second interconnect housing;
a second interconnect housing having at least a second section having a second plurality of second chambers extending generally adjacent each other throughout said second section, each of said second plurality of second chambers having a first open end and a second open end, and an interior, each of said second plurality of second chambers for accepting at least the other of said terminus body and said terminus body assembly through said first open end such that said second interconnect housing will be utilizable as a multi-contact female connector against said complementary first interconnect housing as a multi-contact female connector, each of said second plurality of said second chambers including at least a second plurality of locking rings for holding an associated said other one of said terminus body and said terminus body assembly in a position to resist backing out of each of said associated said other one of said terminus body and said terminus body assembly away from said second end of said second plurality of second chambers, and including structure for fixing said second interconnect housing to said first interconnect housing.

21. The multi-pin connector assembly as recited in claim 20 wherein said at least a first section includes a boss surrounding at least one of said second open end of said first plurality of first chambers, and wherein said at least a second section includes a bevel surrounding at least one of said second open end of said second plurality of second chambers in alignment with said boss to form a seal therewith.

22. A connector termination for providing an interconnection for a terminus body comprising:
an termination housing having a first open end for accepting said terminus body and a second open end for securely supporting an electronic component, an exterior and an interior, said interior having a chamber extending throughout said interior of said connector assembly and between said first and said second open ends for providing communication within said chamber, said chamber further including at least a first locking ring chamber for securely engaging said terminus body; and
a first locking ring having a generally cylindrically shaped body with at least one concentrically inwardly disposed locking finger directed away from said first end of said termination housing.

23. The connector assembly as recited in claim 22 and further comprising at least one grommet located between said first locking ring chamber and said first open end of said termination housing.

24. The connector assembly as recited in claim 22 wherein said chamber has a dimension to produce a gap between said electronic component and said terminus body.
